(19) United States
(12) Patent Application Publication
(10) Pub. No.: US 2025/0233300 A1
(43) Pub. Date: Jul. 17, 2025

(54) ANTENNA AND COMMUNICATION DEVICE

(71) Applicant: Sony Group Corporation, Tokyo (JP)

(72) Inventor: Tomoo KOBAYASHI, Tokyo (JP)

(73) Assignee: Sony Group Corporation, Tokyo (JP)

(21) Appl. No.: 18/701,617

(22) PCT Filed: Sep. 29, 2022
(86) PCT No.: PCT/JP2022/036330

§ 371 Date: Apr. 16, 2024

(30) Foreign Application Priority Data
Nov. 2, 2021 (JP) 2021-179245

(51) Int. Cl. H01Q 1/22

(52) U.S. Cl. CPC H01Q 1/22

(57) ABSTRACT

An antenna includes a wiring portion. The wiring portion, being a conductive portion, is disposed on a substrate, and extends from a proximal end on which the power supply portion is provided to a distal end. The wiring portion has at least a main surface of the distal end exposed.

### FIELD

The present disclosure relates to an antenna and a communication device.

### BACKGROUND

There is known a disclosed antenna including a conductor layer located on a substrate such as a printed circuit board (refer to Patent Literature 1, for example).

### CITATION LIST

### Patent Literature

Patent Literature 1: JP 6-140831 A

### SUMMARY

### Technical Problem

The present disclosure proposes an antenna and a communication device capable of reducing manufacturing cost.

### Solution to Problem

According to the present disclosure, there is provided an antenna. The antenna includes a wiring portion. The wiring portion, being a conductive portion, is disposed on a substrate, and extends from a proximal end on which the power supply portion is provided to a distal end. The wiring portion has at least a main surface of the distal end exposed.

### BRIEF DESCRIPTION OF DRAWINGS

FIG. 1 is a top view illustrating an example of a configuration of a communication device and an antenna according to an embodiment of the present disclosure.

FIG. 2 is a cross-sectional view taken along line A-A illustrated in FIG. 1 as viewed in the direction of arrows.

FIG. 3 is a flowchart illustrating an example of a procedure of antenna inspection processing according to the embodiment of the present disclosure.

FIG. 4 is a top view illustrating an example of a configuration of a communication device and an antenna according to a first modification of the embodiment of the present disclosure.

FIG. 5 is a top view illustrating an example of a configuration of a communication device and an antenna according to a second modification of the embodiment of the present disclosure.

FIG. 6 is a top view illustrating an example of a configuration of a communication device and an antenna according to a third modification of the embodiment of the present disclosure.

FIG. 7 is a bottom view illustrating an example of a configuration of a communication device and an antenna according to the third modification of the embodiment of the present disclosure.

FIG. 8 is a cross-sectional view taken along line B-B illustrated in FIG. 6 as viewed in the direction of arrows.

### DESCRIPTION OF EMBODIMENTS

Hereinafter, embodiments of the present disclosure will be described with reference to the drawings. Note that the present disclosure is not limited to the following embodiments. Furthermore, each of the above-described embodiments can be appropriately combined within a range implementable without contradiction of processing. In each of the following embodiments, the same parts are denoted by the same reference symbols, and a repetitive description thereof will be omitted.

In the embodiment described below, expressions such as “constant”, “orthogonal”, “vertical”, or “parallel” may be used, but these expressions are not necessarily intended to strictly mean “constant”, “orthogonal”, “vertical”, or “parallel”. That is, each expression described above is supposed to allow deviation in accuracy such as manufacturing accuracy and installation accuracy, for example.

There is a disclosed antenna including a conductor layer located on a substrate such as a printed circuit board. This antenna has a main surface of the conductor layer entirely covered with a resist film at locations other than the power supply portion, making it possible to achieve satisfactory reliability.

In addition, in order to inspect whether the antenna is satisfactorily formed on the substrate, the above-described known technique uses a method in which an inspection coaxial connector is attached to a power supply portion of the antenna to measure S-parameters of the antenna, thereby performing pass/fail determination of the antenna.

In addition, other inspection methods include a method of using an Over the Air (OTA) test that determines whether desired antenna characteristics can be obtained after all the elements included in the communication device are mounted on the same substrate as the antenna.

On the other hand, the method of performing pass/fail determination of the antenna by the S-parameters of the antenna needs a significant cost in a coaxial connector and a measuring facility of S-parameters. In addition, in a case where a defect occurs in the antenna in the method of performing pass/fail determination of the antenna by the OTA test, the defective product needs to be discarded after proceeding to a step of mounting elements included in the communication device on the substrate, requiring a large disposal cost.

That is, the above-described known technique has room for further improvement in terms of reducing the manufacturing cost of the antenna. In view of this, there is a high demand for implementation of a technique capable of overcoming the above-described problems and reducing the manufacturing cost of the antenna.

### EMBODIMENT

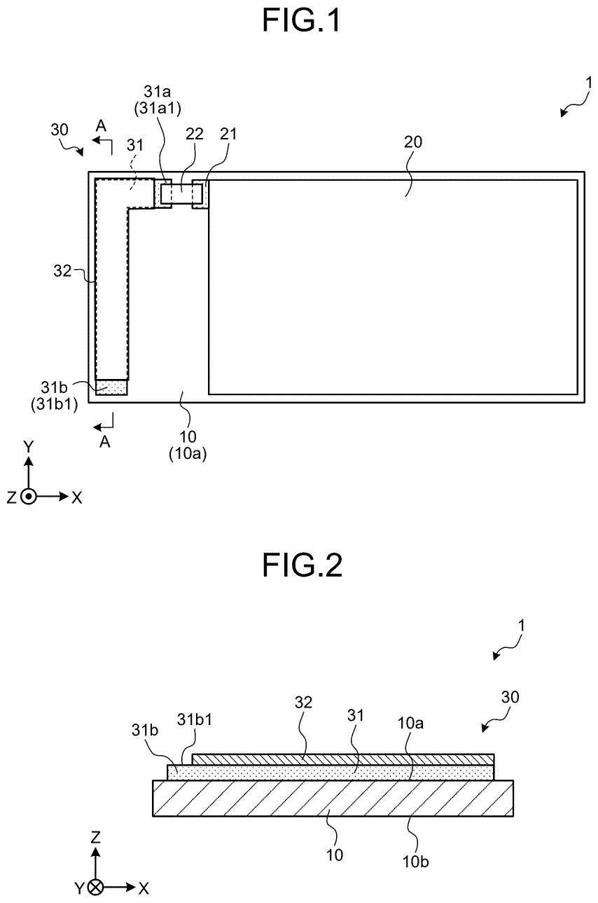

First, a configuration and an inspection method of a communication device 1 and an antenna 30 according to an embodiment will be described with reference to FIGS. 1 to 3. FIG. 1 is a top view illustrating an example of a configuration of the communication device 1 and the antenna 30 according to the embodiment of the present disclosure. FIG. 2 is a cross-sectional view taken along line A-A illustrated in FIG. 1.

For clarity of description, each of the following drawings defines an X-axis direction, a Y-axis direction, and a Z-axis direction orthogonal to each other. In addition, in this orthogonal coordinate system, a facing direction of main surfaces 10a and 10b of a substrate 10 is the Z-axis direction, while the X-axis direction and the Y-axis direction are directions orthogonal to the Z-axis.

As illustrated in FIGS. 1 and 2, the communication device 1 includes the substrate 10, a communication unit 20, and the antenna 30.

The substrate 10 has a flat plate shape and has a pair of the main surfaces 10a and 10b. The main surface 10a is an example of one main surface, and the main surface 10b is an example of the other main surface. Various elements (not illustrated) can be mounted on the substrate 10. The substrate 10 can be implemented by using a substrate such as a rigid substrate, a flexible substrate, and a rigid flexible substrate, for example.

The communication unit 20 performs wireless communication by using the antenna 30. For example, the communication unit 20 outputs, to the antenna 30, an electric signal modulated by an internal modulator (not illustrated), for example, as an electric signal corresponding to a radio wave to be transmitted.

Furthermore, the communication unit 20 collects an electric signal corresponding to the radio wave received by the antenna 30 from the antenna 30.

The communication unit 20 includes a wiring portion 21 and an adjustment element 22 in addition to various elements (not illustrated) constituting a communication circuit for wireless communication. The wiring portion 21 is a terminal portion provided for connection with the antenna 30 in the communication unit 20, and is formed of a conductive thin film (for example, a copper thin film or the like).

The adjustment element 22 is provided to adjust the resonance frequency of the antenna 30, for example. The adjustment element 22 is, for example, an inductor or a capacitor, and is provided across the wiring portion 21 and a proximal end 31a of the antenna 30.

In the embodiment, the element provided across the wiring portion 21 and the proximal end 31a of the antenna 30 is not limited to the adjustment element for adjusting the resonance frequency of the antenna 30, and may be implemented by using other various elements.

In addition, a region where the communication unit 20 is provided on the main surface 10a of the substrate 10 may include a conductive ground (GND) thin film (not illustrated) included in the antenna 30.

The antenna 30 is an interface for transmitting and receiving an electric signal between the communication unit 20 and another communication device or the like by wireless communication. The antenna 30 includes a wiring portion 31 and a protective film 32.

The wiring portion 31, disposed on the main surface 10a of the substrate 10, is formed of a conductive thin film (thin film such as a copper thin film, for example). As illustrated in FIG. 1, the wiring portion 31 extends from the proximal end 31a close to the communication unit 20 to a distal end 31b as lines forming a predetermined shape (substantially L shape in the example of FIG. 1). The proximal end 31a of the wiring portion 31 includes a power supply portion of the antenna 30.

The protective film 32 is disposed so as to cover a predetermined part of the wiring portion 31. The protective film 32 is disposed so as to cover the main surface of the wiring portion 31 formed of a thin film on the side opposite to the side in contact with the substrate 10. The protective film 32 is formed of a resin material such as a solder resist, for example.

Disposing such a protective film 32 makes it possible to suppress deterioration of the wiring portion 31 due to various environmental factors, leading to increased reliability of the communication device 1.

Here, in the embodiment, as illustrated in FIGS. 1 and 2, a main surface 31b1 of the distal end 31b is exposed in the wiring portion 31. That is, in the embodiment, the main surface 31b1 of the distal end 31b is not covered with the protective film 32. This configuration allows a measurement probe to be brought into contact with the main surface 31b1 of the distal end 31b.

In addition, in the embodiment, a main surface 31al of the proximal end 31a is also exposed before the adjustment element 22 is mounted. This makes it possible to bring the measurement probe into contact with the main surface 31al of the proximal end 31a similarly.

Accordingly, the embodiment can use a method of measuring the electrical resistance value between the distal end 31b and the proximal end 31a, as a method of performing pass/fail determination of the antenna 30. This is because occurrence of a defect such as disconnection, a short circuit, or disturbance of the line width in the wiring portion 31, which is formed as patterned wiring, leads to a difference in an electrical resistance value between the distal end 31b and the proximal end 31a of the wiring portion 31 from the value in the normal case.

That is, the embodiment makes it possible to perform pass/fail determination of the antenna 30 by a simple method of having the main surface 31b1 of the distal end 31b in the wiring portion 31 exposed. Therefore, according to the embodiment, the manufacturing cost of the antenna 30 can be reduced.

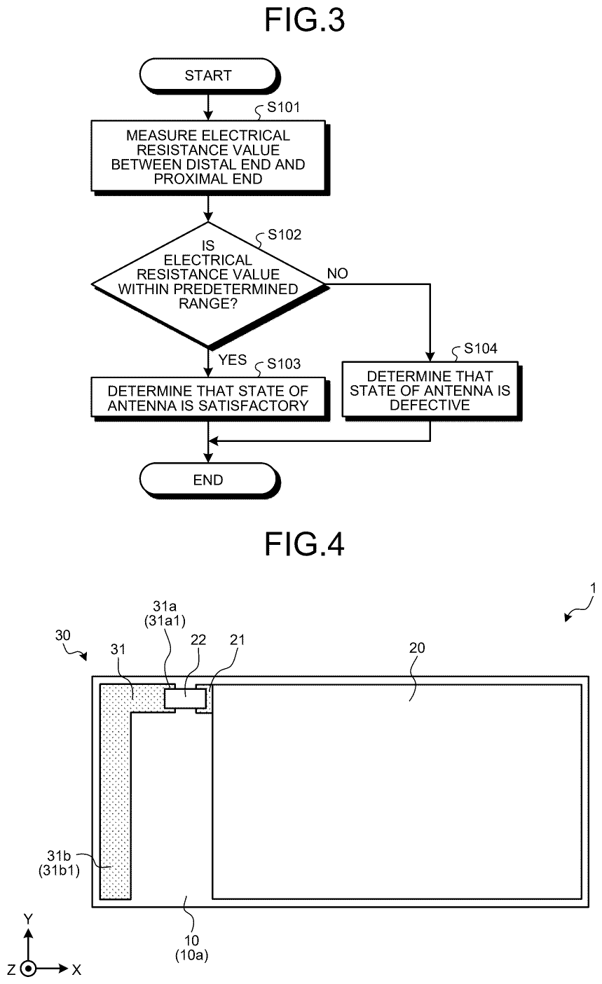

FIG. 3 is a flowchart illustrating an example of a procedure of inspection processing of the antenna 30 according to the embodiment of the present disclosure. First, an operator or the like measures the electrical resistance value between the distal end 31b and the proximal end 31a of the antenna 30 using a measuring instrument capable of measuring the electrical resistance value (Step S101).

For example, the operator or the like brings a measurement probe into contact with the main surface 31b1 of the distal end 31b and the main surface 31al of the proximal end 31a to measure the electrical resistance value between the distal end 31b and the proximal end 31a.

Next, the operator or the like determines whether the measured electrical resistance value of the antenna 30 is within a predetermined range (Step S102). In the embodiment, for example, the electrical resistance value of the antenna 30, being the antenna 30 having the same specification and normally operating, may be evaluated in advance, and a range approximate to the evaluated electrical resistance value can be used as the predetermined range.

When the electrical resistance value of the antenna 30 is within the predetermined range (Step S102, Yes), it is determined that the state of the antenna 30 is satisfactory (Step S103). In contrast, when the electrical resistance value of the antenna 30 is not within the predetermined range (Step S102, No), the state of the antenna 30 is determined to be defective (Step S104). When the processing of Step S103 or Step S104 is completed, a series of processing ends.

With such inspection processing, it is possible to perform pass/fail determination of the antenna 30 in a step before mounting various elements included in the communication unit 20, leading to reduction of the disposal cost when the antenna 30 is defective. In addition, the electrical resistance value measurement device used in the inspection processing has a lower implementation cost compared with the case of the S-parameter measurement facility.

In this manner, the embodiment uses a configuration in which the main surface 31b1 of the distal end 31b is also exposed in addition to the proximal end 31a provided with the power supply portion in a state before various elements are mounted on the substrate 10, making it possible to reduce the manufacturing cost of the antenna 30.

In the embodiment, the wiring portion 31 may be preferably configured to have its main surface covered with the protective film 32 at locations other than the proximal end 31a and the distal end 31b. This makes it possible to suppress deterioration of the wiring portion 31 due to various environmental factors, leading to increased reliability of the communication device 1.

The above example is an example in which an operator or the like performs the inspection processing of the antenna 30. However, the present disclosure is not limited to such an example, and the inspection processing of the antenna 30 may be performed, for example, using a robot or the like.

### Various Modifications

Next, various modifications of the embodiment will be described with reference to FIGS. 4 to 8. FIG. 4 is a top view illustrating an example of a configuration of the communication device 1 and the antenna 30 according to a first modification of the embodiment of the present disclosure.

As illustrated in FIG. 4, the first modification uses a configuration in which the whole main surface from the distal end 31b to the proximal end 31a is exposed in addition to the main surface 31b1 of the distal end 31b. That is, the protective film 32 is not provided on the antenna 30 in the first modification.

Even with such a configuration, in a state before various elements are mounted on the substrate 10, the main surface 31b1 of the distal end 31b is also exposed in addition to the proximal end 31a provided with the power supply portion, making it possible to perform pass/fail determination of the antenna 30 with a simple method. Therefore, according to first modification, the manufacturing cost of the antenna 30 can be reduced.

In the first modification, the antenna 30 is not provided with the protective film 32, making it possible to facilitate visual recognition of the planar shape of the wiring portion 31. Therefore, according to the first modification, it is possible to further facilitate pass/fail determination of the antenna 30.

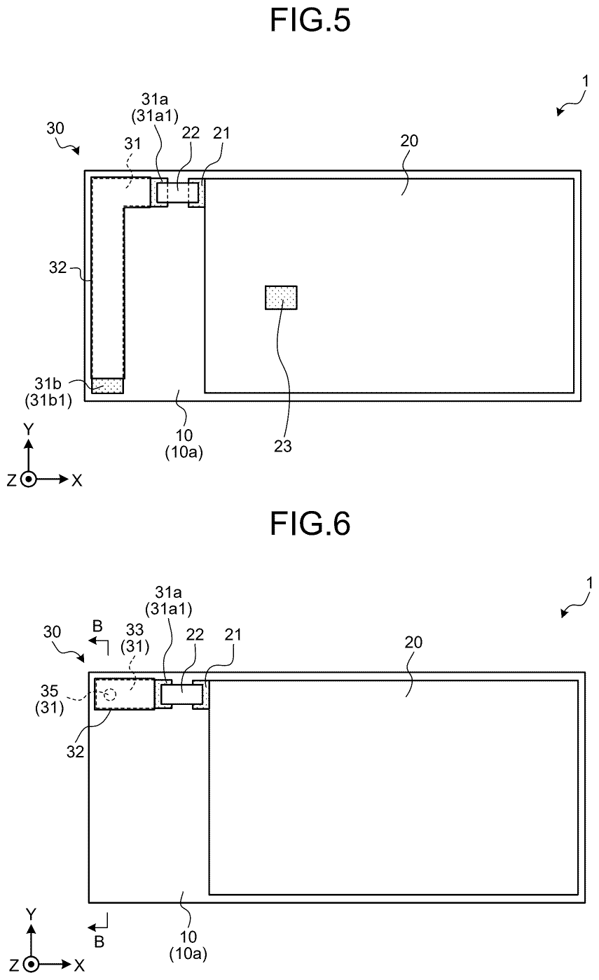

FIG. 5 is a top view illustrating an example of a configuration of the communication device 1 and the antenna 30 according to a second modification of the embodiment of the present disclosure. As illustrated in FIG. 5, in the second modification, the main surface of a wiring portion 23 is exposed in a region on the main surface 10a of the substrate 10 where the communication unit 20 is provided. The wiring portion 23 is electrically connected to the wiring portion 21.

In the second modification, since the main surface of the wiring portion 23 is exposed, even after the adjustment element 22 is mounted on the power supply portion of the antenna 30, it is possible to perform pass/fail determination of the antenna 30 by measuring the electrical resistance value between the wiring portion 23 and the distal end 31b of the antenna 30.

That is, in the second modification, the determination processing of the antenna 30 can be performed not only before the step of mounting various elements on the substrate 10 but also after the mounting step.

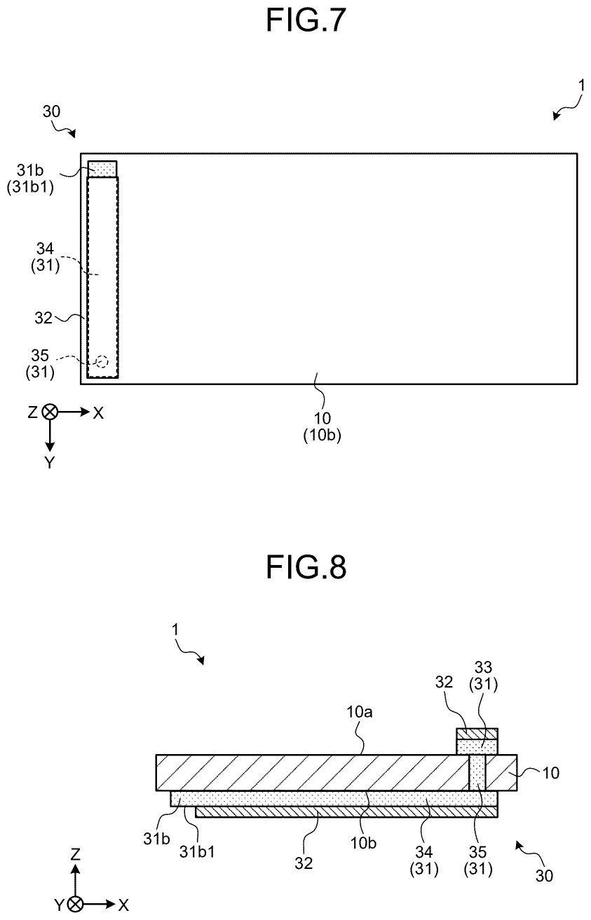

FIG. 6 is a top view illustrating an example of a configuration of the communication device 1 and the antenna 30 according to a third modification of the embodiment of the present disclosure. FIG. 7 is a bottom view illustrating an example of the configuration of the communication device 1 and the antenna 30 according to the third modification of the embodiment of the present disclosure. FIG. 8 is a cross-sectional view taken along line B-B illustrated in FIG. 6 as viewed in the direction of arrows.

As illustrated in FIGS. 6 to 8, the wiring portion 31 in the antenna 30 in the third modification has a difference in configuration from the embodiment. Specifically, in the third modification, the wiring portion 31 includes a first wiring layer 33, a second wiring layer 34, and a via conductor 35.

As illustrated in FIG. 6 and the like, the first wiring layer 33 is disposed on the main surface 10a of the substrate 10. The first wiring layer 33 extends from the proximal end 31a close to the communication unit 20 to a predetermined portion where the via conductor 35 is disposed. The proximal end 31a of the wiring portion 31 located in the first wiring layer 33 includes the power supply portion of the antenna 30.

As illustrated in FIG. 7 and the like, the second wiring layer 34 is disposed on the main surface 10b of the substrate 10. The second wiring layer 34 extends from a predetermined portion where the via conductor 35 is disposed to the distal end 31b of the wiring portion 31 provided in the second wiring layer 34.

As illustrated in FIG. 8, the via conductor 35 penetrates from the main surface 10a to the main surface 10b of the substrate 10, so as to electrically connect the first wiring layer 33 and the second wiring layer 34 to each other.

In addition, both the main surface of the first wiring layer 33 other than the proximal end 31a and the main surface of the second wiring layer 34 other than the distal end 31b are covered with the protective film 32.

In this manner, the wiring portion 31 includes the second wiring layer 34 and the via conductor 35 in addition to the first wiring layer 33. Therefore, even when there is no sufficient surplus area of the main surface 10a on which the communication unit 20 is provided, the antenna 30 having a necessary length can be disposed on the substrate 10.

In addition, even with such a configuration, in a state before various elements are mounted on the substrate 10, the main surface 31b1 of the distal end 31b is also exposed in addition to the proximal end 31a on which the power supply portion is located, making it possible to perform pass/fail determination of the antenna 30 with a simple method. Therefore, according to third modification, the manufacturing cost of the antenna 30 can be reduced.

In addition, in the third modification, it is also possible to determine whether the state of the via conductor 35 is satisfactory or not, which is difficult to be checked visually.

### Effects

The antenna 30 according to the embodiment includes the wiring portion 31. The wiring portion 31, which is conductive, is disposed on the substrate 10 so as to extend from the proximal end 31a where the power supply portion is provided to the distal end 31b. The wiring portion 31 has at least the main surface 31b1 of the distal end 31b exposed.

This makes it possible to reduce the manufacturing cost of the antenna 30.

In the antenna 30 according to the embodiment, the wiring portion 31 has the main surface covered at locations other than the main surfaces 31b1 and 31al of the distal end 31b and the proximal end 31a, respectively.

This makes it possible to increase the reliability of the communication device 1.

Furthermore, in the antenna 30 according to the embodiment, the entire main surface of the wiring portion 31 is exposed.

This makes it possible to further facilitate pass/fail determination of the antenna 30.

Furthermore, the antenna 30 according to the embodiment has a configuration in which the wiring portion 31 includes the first wiring layer 33, the second wiring layer 34, and the via conductor 35. The first wiring layer 33 is disposed on the main surface 10a being one surface of the substrate 10, and is provided with the proximal end 31a. The second wiring layer 34 is disposed on the main surface 10b being the other surface of the substrate 10, and is provided with the distal end 31b. The via conductor 35 electrically connects the first wiring layer 33 and the second wiring layer 34 to each other and penetrates the substrate 10.

With this configuration, even when there is no sufficient surplus area of the main surface 10a on which the communication unit 20 is provided, it is possible to dispose the antenna 30 having a necessary length on the substrate 10, and possible to reduce the manufacturing cost of the antenna 30.

The antenna 30 according to the embodiment has a configuration in which the communication unit 20 that performs wireless communication by the antenna 30 is disposed on the substrate 10. Furthermore, the communication unit 20 includes another wiring portion 21 disposed close to the proximal end 31a, and yet another wiring portion 23 disposed away from the another wiring portion 21 and electrically connected to the another wiring portion 21. The still another wiring portion 23 has its main surface exposed.

With this configuration, the determination processing of the antenna 30 can be performed not only before the step of mounting various elements on the substrate 10 but also after the mounting step.

Furthermore, the communication device 1 according to the embodiment includes: the antenna 30; and the communication unit 20 that performs wireless communication using the antenna 30. The antenna 30 includes the wiring portion 31. The wiring portion 31, which is conductive, is disposed on the substrate 10 so as to extend from the proximal end 31a where the power supply portion is provided to the distal end 31b. The wiring portion 31 has at least the main surface 31b1 of the distal end 31b exposed.

This makes it possible to reduce the manufacturing cost of the communication device 1.

The embodiments of the present disclosure have been described above. However, the technical scope of the present disclosure is not limited to the above-described embodiments, and various modifications can be made without departing from the scope of the present disclosure. Moreover, it is allowable to combine the components across different embodiments and modifications as appropriate.

For example, the above embodiment is an example in which the communication unit 20 and the antenna 30 are disposed on the same substrate 10. However, the present disclosure is not limited to such an example, and the communication unit 20 and the antenna 30 may be disposed on mutually different substrates.

The above embodiment is an example in which the side surface of the wiring portion 31, which is formed as patterned wiring, is not covered with the protective film 32. However, the present disclosure is not limited to such an example, and the side surface of the wiring portion 31 may be covered with the protective film 32.

The effects described in the present specification are merely examples, and thus, there may be other effects, not limited to the exemplified effects.

Note that the present technique can also have the following configurations.

(1)

An antenna comprising a wiring portion which is a conductive portion disposed on a substrate and extending from a proximal end at which a power supply portion is provided to a distal end,
wherein the wiring portion has at least its main surface of the distal end exposed.
   (2)

The antenna according to the above (1),
wherein the wiring portion has its main surface covered at locations other than the main surfaces of the distal end and the proximal end.
   (3)

The antenna according to the above (1),
wherein the wiring portion has its entire main surface exposed.
   (4)

The antenna according to any one of the above (1) to (3),
wherein the wiring portion includes:
a first wiring layer disposed on one main surface of the substrate and provided with the proximal end;
a second wiring layer disposed on the other main surface of the substrate and provided with the distal end; and
a via conductor that electrically connects the first wiring layer and the second wiring layer to each other and penetrates the substrate.
   (5)

The antenna according to any one of the above (1) to (4),
wherein a communication unit that performs wireless communication by the antenna is disposed on the substrate,
the communication unit includes:
another wiring portion disposed close to the proximal end; and
still another wiring portion that is disposed away from the another wiring portion and is electrically connected to the another wiring portion, and
the still another wiring portion has its main surface exposed.
   (6)

A communication device comprising:
an antenna; and
a communication unit that performs wireless communication by using the antenna,
wherein the antenna includes a wiring portion which is a conductive portion disposed on a substrate and extending from a proximal end at which a power supply portion is provided to a distal end, and
the wiring portion has at least its main surface of the distal end exposed.
   (7)

The communication device according to the above (6),
wherein the wiring portion has its main surface covered at locations other than the main surfaces of the distal end and the proximal end.
   (8)

The communication device according to (6),
wherein the wiring portion has its entire main surface exposed.
   (9)

The communication device according to any one of the above (6) to (8),
wherein the wiring portion includes:
a first wiring layer disposed on one main surface of the substrate and provided with the proximal end;
a second wiring layer disposed on the other main surface of the substrate and provided with the distal end; and
a via conductor that electrically connects the first wiring layer and the second wiring layer to each other and penetrates the substrate.
   (10)

The communication device according to any one of the above (6) to (9),
wherein a communication unit that performs wireless communication by the antenna is disposed on the substrate,
the communication unit includes:
another wiring portion disposed close to the proximal end; and
still another wiring portion that is disposed away from the another wiring portion and is electrically connected to the another wiring portion, and
the still another wiring portion has its main surface exposed.
   (11)

An antenna inspection method, which is a method of inspecting an antenna, the antenna including a wiring portion which is a conductive portion disposed on a substrate and extending from a proximal end at which a power supply portion is provided to a distal end, the wiring portion having at least its main surface of the distal end exposed,
the method comprising:
a step of measuring an electrical resistance value between the distal end and the proximal end of the antenna; and
a step of performing pass/fail determination of the antenna based on the electrical resistance value measured.
   (12)

The antenna inspection method according to the above (11),
wherein the step of performing determination includes determination that the antenna is normal when the electrical resistance value is within a predetermined range.
   (13)

The antenna inspection method according to the above (11) or (12),
wherein the wiring portion has its main surface covered at locations other than the main surfaces of the distal end and the proximal end.
   (14)

The antenna inspection method according to the above (11) or (12),
wherein the wiring portion has its entire main surface exposed.
   (15)

The antenna inspection method according to any one of the above (11) to (14),
wherein the wiring portion includes:
a first wiring layer disposed on one main surface of the substrate and provided with the proximal end;
a second wiring layer disposed on the other main surface of the substrate and provided with the distal end; and
a via conductor that electrically connects the first wiring layer and the second wiring layer to each other and penetrates the substrate.
   (16)

The antenna inspection method according to any one of the above (11) to (15),
wherein a communication unit that performs wireless communication by the antenna is disposed on the substrate,
the communication unit includes:
another wiring portion disposed close to the proximal end; and
still another wiring portion that is disposed away from the another wiring portion and is electrically connected to the another wiring portion, and
the still another wiring portion has its main surface exposed.

### REFERENCE SIGNS LIST

1 COMMUNICATION DEVICE
10 SUBSTRATE
10a MAIN SURFACE (EXAMPLE OF ONE MAIN SURFACE)
10b MAIN SURFACE (EXAMPLE OF THE OTHER MAIN SURFACE)
20 COMMUNICATION UNIT
21 WIRING PORTION (EXAMPLE OF ANOTHER WIRING PORTION)
23 WIRING PORTION (EXAMPLE OF STILL ANOTHER WIRING PORTION)
30 ANTENNA
31 WIRING PORTION
31a PROXIMAL END
31a1 MAIN SURFACE
31b DISTAL END
31b1 MAIN SURFACE
32 PROTECTIVE FILM
33 FIRST WIRING LAYER
34 SECOND WIRING LAYER
35 VIA CONDUCTOR

1. An antenna comprising a wiring portion which is a conductive portion disposed on a substrate and extending from a proximal end at which a power supply portion is provided to a distal end,
wherein the wiring portion has at least its main surface of the distal end exposed.

2. The antenna according to claim 1,
wherein the wiring portion has its main surface covered at locations other than the main surfaces of the distal end and the proximal end.

3. The antenna according to claim 1,
wherein the wiring portion has its entire main surface exposed.

4. The antenna according to claim 1,
wherein the wiring portion includes:
a first wiring layer disposed on one main surface of the substrate and provided with the proximal end;
a second wiring layer disposed on the other main surface of the substrate and provided with the distal end; and
a via conductor that electrically connects the first wiring layer and the second wiring layer to each other and penetrates the substrate.

5. The antenna according to claim 1,
wherein a communication unit that performs wireless communication by the antenna is disposed on the substrate,
the communication unit includes:
another wiring portion disposed close to the proximal end; and
still another wiring portion that is disposed away from the another wiring portion and is electrically connected to the another wiring portion, and
the still another wiring portion has its main surface exposed.

6. A communication device comprising:
an antenna; and
a communication unit that performs wireless communication by using the antenna,
wherein the antenna includes a wiring portion which is a conductive portion disposed on a substrate and extending from a proximal end at which a power supply portion is provided to a distal end, and
the wiring portion has at least its main surface of the distal end exposed.
